(19) United States
(12) Patent Application Publication
(10) Pub. No.: US 2006/0183659 A1
(43) Pub. Date: Aug. 17, 2006

(54) Solid laundry detergent composition

(75) Inventors: Anthony Dovey, Northumberland (GB); Mark Allen Smerznak, Whitley Bay (GB); Lourdes Marina Ramirez Hernandez, Wallsend (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 11/351,719

(22) Filed: Feb. 10, 2006

(30) Foreign Application Priority Data
Feb. 11, 2005 (EP) 05250778.7

(51) Int. Cl. C11D 17/00

(52) U.S. Cl. 510/424

(57) ABSTRACT

The present invention relates to a solid laundry detergent composition comprising: (a) a linear alkyl benzene sulphonate surfactant; (b) an alkoxylated alkyl sulphate surfactant; (c) from 0.1 wt % to 10 wt % alkoxylated alkyl alcohol having an average degree of alkoxylation of from 50 to 100; and (d) from 0.001 wt % to 0.5 wt % polyethylene glycol; (e) from 0 wt % to 5 wt % zeolite builder; (f) from 0 wt % to 5 wt % phosphate builder; and (g) optionally, one or more adjunct components; wherein the weight ratio of the alkoxylated alkyl alcohol and the polyethylene glycol is in the range of from 9:1 to 1,000:1.

### FIELD OF THE INVENTION

The present invention relates to solid laundry detergent compositions. In particular the present invention relates to a laundry detergent composition in granular form or other solid form such as a tablet, having a good fabric cleaning performance together with good product dispensing and dissolution characteristics.

### BACKGROUND OF THE INVENTION

Solid laundry detergent compositions need to have a very good fabric-cleaning performance against a wide variety of soil types. Solid laundry detergents also need to have very good dispensing and dissolution profiles. However, a dichotomy may exist in that some reformulations of the solid laundry detergent composition to improve its fabric-cleaning performance may negatively impact its dispensing and dissolution profiles, and vice versa. It is very difficult to improve the cleaning performance, dispensing profile and dissolution profile of a solid laundry detergent composition at the same time.

Anionic detersive surfactants are incorporated into granular laundry detergent compositions in order to provide a good fabric-cleaning benefit. For example, GB1408969, GB1408970, U.S. Pat. No. 4,487,710, U.S. Pat. No.5,663,136 and WO2004/041982 all relate to compositions comprising anionic detersive surfactants. However, the anionic detersive surfactant is capable of complexing with free cations, such as calcium and magnesium cations, that are present in the wash liquor in such a manner as to cause the anionic detersive surfactant to precipitate out of solution, which leads to a reduction in the anionic detersive surfactant activity. In extreme cases, these water-insoluble complexes may deposit onto the fabric resulting in poor whiteness maintenance and poor fabric integrity benefits. This is especially problematic when the laundry detergent composition is used in hard-water washing conditions when there is a high concentration of calcium cations.

The anionic detersive surfactant's tendency to complex with free cations in the wash liquor in such a manner as to precipitate out of solution is mitigated by the presence of builders, such as zeolite builders and phosphate builders, which have a high binding constant with cations such as calcium and magnesium cations. These builders sequester free calcium and magnesium cations and reduce the formation of these undesirable complexes. However, zeolite builders are water-insoluble and their incorporation in laundry detergent compositions leads to poor dissolution of the laundry detergent composition and can also lead to undesirable residues being deposited on the fabric. In addition, detergent compositions that comprise high levels of zeolite builder form undesirable cloudy wash liquors upon contact with water. Whilst phosphate builders allegedly do not have favourable environmental profiles and their use in laundry detergent compositions is becoming less common; for example, due to phosphate legislation in many countries.

Detergent compositions comprising alkyl benzene sulphonate and alkyl ethoxylated sulphate detersive surfactants are described in GB1408969, GB1408970, U.S. Pat. No. 4,487,710 and U.S. Pat. No. 5,663,136. A detergent composition comprising an anionic detersive surfactant and a non-ionic detersive surfactant that allegedly gives enhanced stain removal at a wide range of water-hardness is described in WO2004/041982. A combination of a granular detergent and a packaging system having a low moisture vapour transfer rate is described in EP634484.

There remains a need for a solid laundry detergent composition comprising an anionic detersive surfactant having a good fabric-cleaning performance, especially a good greasy stain cleaning performance, good whiteness maintenance and very good dispensing and dissolution profiles.

### SUMMARY OF THE INVENTION

The Inventors have found that controlling the weight ratio of an alkoxylated alkyl alcohol and a polyethylene glycol that are present in a solid laundry detergent composition that additionally comprises (i) a linear alkyl benzene sulphonate surfactant, (ii) an alkoxylated alkyl sulphate surfactant and (iii) nil, or low levels of, zeolite builder and phosphate builder, provides a good fabric-cleaning performance and very good dispensing and dissolution profiles.

The present invention provides a solid laundry detergent composition comprising: (a) a linear alkyl benzene sulphonate surfactant; (b) an alkoxylated alkyl sulphate surfactant; (c) from 0.1 wt % to 10 wt % alkoxylated alkyl alcohol having an average degree of alkoxylation of from 50 to 100; and (d) from 0.001 wt % to 0.5 wt % polyethyleneglycol; (e) from 0 wt % to 5 wt % zeolite builder; (f) from 0 wt % to 5 wt % phosphate builder; (g) optionally, one or more adjunct components; wherein the weight ratio of the alkoxylated alkyl alcohol to the polyethyleneglycol is in the range of from 9:1 to 1,000:1.

### DETAILED DESCRIPTION OF THE INVENTION

Linear Alkyl Benzene Sulphonate Surfactant

The composition comprises a linear alkyl benzene sulphonate surfactant. The composition typically comprises from 0.1 wt % to 35 wt %, preferably from 5 wt %, or from 10 wt %, and preferably to 30 wt %, or to 25 wt %, or to 20 wt % linear alkyl benzene sulphonate. The linear alkyl benzene sulphonate may be substituted or unsubstituted. Preferably, the linear alkyl benzene sulphonate is a C₈-C₁₈, preferably a C₁₁-C₁₃ alkyl benzene sulphonate.

Alkoxylated Alkyl Sulphate Surfactant

The composition comprises an alkoxylated alkyl sulphate surfactant. The alkoxylated alkyl sulphate surfactant, or at least a portion thereof, may be linear or branched, substituted or unsubstituted.

The composition typically comprises from 0.1 wt % to 10 wt %, preferably from 0.5 wt %, or from 1 wt %, and preferably to 8 wt %, or to 6 wt %, or to 4 wt %, by weight of the composition, of an alkyl alkoxylated sulphate surfactant. The alkyl alkoxylated sulphate surfactant preferably has an average degree of alkoxylation of from 1 to 7, preferably from 2, or from 3, and preferably to 5 or to 3. Preferably, alkyl alkoxylated sulphate surfactant has an average degree of alkoxylation of 3. The alkoxylation moiety is preferably methoxy, ethoxy, propoxy or butoxy, preferably ethoxy.

If the alkoxylated alkyl alkoxylated sulphate surfactant is branched, then typically it is branched with a C₁-C₃ alkyl moiety, preferably a methyl, or preferably an ethyl moiety. Preferably, the branched alkyl alkoxylated sulphate surfactant is a C₈-C₁₈, or a C₁₂-C₁₅ alkyl ethoxylated sulphate surfactant that is branched with a C₁-C₃ alkyl moiety. Suitable branched alkyl alkoxylated surfactants typically have an average degree of branching of from 0.2 to 0.8, preferably from 0.5 to 0.6.

The alkyl alkoxylated sulphate surfactant preferably has an alkyl chain length distribution such that (a) less than 1.2 wt % by weight of the alkyl chains, are alkyl chains having a chain length of less than 12 carbon atoms; (b) from 0 wt % to 30 wt %, or from 5 wt % to 20 wt % by weight of the alkyl chains, are alkyl chains having a chain length of 12 carbon atoms; (c) from 10 wt % to 60 wt %, preferably from 40 wt % to 50 wt % by weight of the alkyl chains, are alkyl chains having a chain length of 14 carbon atoms; and (d) less than 4 wt % by weight of the alkyl chains, are alkyl chains having a chain length of greater than 15 carbon atoms.

Alkoxylated Alkyl Alcohol

The composition comprises from 0.1 wt % to 10 wt %, preferably from 0.5 wt %, or from 1.0 wt %, or from 1.5 wt %, or even from 2.0 wt %, and preferably to 8 wt %, or 6 wt %, or 5 wt % or 4 wt %, or even 3 wt %, by weight of the composition, of an alkoxylated alkyl alcohol. The alkoxylated alkyl alcohol has an average degree of alkoxylation of from 50 to 100, preferably from 60, or from 70, or from 80, and preferably to 90 or to 80. The alkoxylated alkyl alcohol is typically a C₈-C₂₄, preferably a C₁₆-C₁₈ alkyl alkoxylated alcohol. The alkoxylated alkyl alcohol is preferably an alkoxylated tallow alkyl alcohol. Preferably the alkoxy moiety is a methoxy, an ethoxy, a propoxy or a butoxy, preferably an ethoxy moiety. Preferably, the alkoxylated alkyl alcohol is an ethoxylated tallow alkyl alcohol.

Polyethylene Glycol

The composition comprises from 0.001 wt % to 0.5 wt %, preferably from 0.1 wt %, or from 0.5 wt %, and preferably to 0.25 wt %, or to 0.1 wt % polyethylene glycol.

Solid Laundry Detergent Composition

The solid laundry detergent composition comprises: (a) a linear alkyl benzene sulphonate surfactant; (b) an alkoxylated alkyl sulphate surfactant; (c) from 0.1 wt % to 10 wt % alkoxylated alkyl alcohol having an average degree of alkoxylation of from 50 to 100; and (d) from 0.001 wt % to 0.5 wt % polyethylene glycol; (e) from 0 wt % to 5 wt % zeolite builder; (f) from 0 wt % to 5 wt % phosphate builder; and (g) optionally, one or more adjunct components; wherein the weight ratio of the alkoxylated alkyl alcohol to the polyethylene glycol is in the range of from 9:1 to 1,000:1.

Preferably, the weight ratio of alkoxylated alkyl alcohol to polyethylene glycol is in the range of from 15:1, or from 20:1, or from 25:1, or from 30:1, and preferably to 500:1, or to 250:1, or to 200:1, or to 150:1, or to 100:1, or to 50:1, or to 40:1.

The composition comprises from 0 wt % to 5 wt %, preferably to 4 wt %, or to 3 wt %, or to 2 wt %, or even to 1 wt % zeolite builder. Preferably, the composition is substantially free of zeolite builder. By substantially free of zeolite builder, it is typically meant that no zeolite builder is deliberately incorporated into the composition. Typical zeolite builders are zeolite A, zeolite P and zeolite MAP.

The composition comprises from 0 wt % to 5 wt %, preferably to 4 wt %, or to 3 wt %, or to 2 wt %, or even to 1 wt % phosphate builder. Preferably, the composition is substantially free of phosphate builder. By substantially free of phosphate builder, it is typically meant that no phosphate builder is deliberately incorporated into the composition. A typical phosphate builder is sodium tri-polyphosphate.

Preferably the linear alkyl benzene sulphonate surfactant, the alkoxylated alkyl sulphate surfactant, the alkoxylated alkyl alcohol and the polyethyleneglycol are in the form of a co-particulate admix; typically this means that the linear alkyl benzene sulphonate surfactant, the alkoxylated alkyl sulphate surfactant, the alkoxylated alkyl alcohol and the polyethyleneglycol are present in the same particle in the composition. The co-particulate admix, or particle, can be in the form of an agglomerate, an extrudate, a flake, a needle, a noodle, a spray-dried particle. Preferably the co-particulate admix, or particle, is in the form of an agglomerate. Preferably, the co-particulate admix has a bulk density of from 400 g/l to 1,500 g/l, more preferably from 800 g/l to 1,200 g/l. Preferably the co-particulate admix, or particle, has a particle size distribution such that no more than 10 wt % by weight of the co-particulate admix, or particle, has a particle size greater than 850 micrometers, and no more than 10 wt % by weight of the co-particulate admix, or particle, has a particle size less than 250 micrometers.

Preferably, the composition has a particle size distribution such that no more than 10 wt % by weight of the composition, has a particle size greater than 850 micrometers, and no more than 10 wt % by weight of the composition, has a particle size less than 250 micrometers.

Adjunct Components

The composition optionally comprises one or more adjunct components. The adjunct components are typically selected from the group consisting of other anionic surfactants, cationic surfactants, non-ionic surfactants, zwitterionic surfactants, other builders, polymeric co-builders such as polymeric polycarboxylates, bleach, other hydrotropes, chelants, enzymes, anti-redeposition polymers, soil-release polymers, polymeric soil-dispersing and/or soil-suspending agents, dye-transfer inhibitors, fabric-integrity agents, fluorescent whitening agents, suds suppressors, fabric-softeners, flocculants, cationic fabric-softening components, perfumes and combinations thereof.

A suitable adjunct component may be an anionic surfactant other than the alkyl alkoxylated sulphate surfactant and the linear alkyl benzene sulphonate surfactant. Suitable other anionic surfactants are branched or linear C₈-C₁₈ alkyl sulphate surfactants. An especially suitable other anionic surfactants are methyl branched C₈-C₁₈ alkyl sulphate surfactants.

A suitable adjunct component is a polymeric polycarboxylate. Suitable polymeric polycarboxylates are co-polymers of maleic acid and acrylic acid, typically having a weight average molecular weight of from 5,000 Da to 10,000 Da, or from 50,000 Da to 90,000 Da. Preferably the molar ratio of maleic acid to acrylic acid is in the range of from 0.25:1 to 0.35:1, or from 1:1 to 0.5:1.

The composition preferably comprises a carbonate source, preferably sodium carbonate and/or sodium bicarbonate. The composition preferably comprises sodium sulphate. Preferably, the weight ratio of the sodium carbonate to sodium sulphate is in the range of from 0.1:1 to 1.5:1, more preferably from 0.2, or from 0.3, or from 0.4, and more preferably to 1.2:1, or to 1:1, or to 0.8:1, or to 0.6:1.

A suitable adjunct component may be a hydrotrope other than the alkoxylated alkyl alcohol. Suitable hydrotropes include sodium cumene sulphate, sodium toluene sulphate and sodium xylene sulphate.

### EXAMPLES

### Example 1

1.1 Anionic Surfactant Agglomerate

| Ingredient | Amount |
|---|---|
| C₁₁-C₁₃ linear alkyl benzene sulphonate (LAS) | 20 wt % |
| C₁₂-C₁₅ alkyl ethoxylated sulphate | 2.4 wt % |
| having an average degree of ethoxylation of 3 (AE₃S) | |
| Co-polymer of maleic acid and acrylic acid | 5.5 wt % |
| having a weight average molecular weight | |
| of from 50,000 Da to 90,000 Da, | |
| and a molar ratio of maleic acid to acrylic acid | |
| of from 0.25 to 0.35 (co-polymer) | |
| Tallow alkyl ethoxylated alcohol | 2.9 wt % |
| having an average degree of ethoxylation of 80 (TAE₈₀) | |
| Polyethylene glycol | 0.1 wt % |
| Sodium sulphate | 40 wt % |
| Sodium carbonate | 20 wt % |
| Water and miscellaneous | 9.1 wt % |

1.2. Agglomeration Process

The above-described anionic surfactant agglomerate (described in example 1.1) is prepared by the following process:

The TAE₈₀, polyethylene glycol, co-polymer and aqueous anionic surfactant paste comprising the LAS and AE₃S are introduced into a twin screw extruder and extruded into a Lodige CB mixer. Dry material comprising the sodium sulphate and sodium carbonate is introduced into the Lodige CB mixer and mixed with the TAE₈₀, polyethylene glycol, co-polymer and anionic surfactant paste to form a mixture. The mixture is then transferred into a Lodige KM mixer, water is sprayed into the KM and the mixture is agglomerated to form intermediate agglomerates. The intermediate agglomerates exiting the Lodige KM mixer are passed through a sieve and intermediate agglomerates having a particle size greater than 5 millimeters are removed from the remainder of the intermediate agglomerates and recycled back to the Lodige CB mixer. The remaining portion of the intermediate agglomerates is transferred into a fluid bed dryer and then a fluid bed cooler. Intermediate agglomerates having a very small particle size (i.e. the fines having a particle size of less than 250 micrometers) are elutriated by the fluid bed exhaust system where they are collected and recycled back to the CB mixer. The remaining portion of the intermediate agglomerates exiting the fluid bed cooler is passed through a sieve and intermediate agglomerates having a particle size greater than 850 micrometers are removed from the remainder of the intermediate agglomerates, passed through a grinder where they are ground into particles having a smaller particle size and are then recycled back to the fluid bed dryer. The remaining portion of the intermediate agglomerates is collected and is suitable for use in the present invention; this remaining portion is the anionic surfactant agglomerates having the above described formulation (example 1.1).

1.3. Solid Laundry Detergent Composition

| Ingredient | Amount |
|---|---|
| Anionic surfactant agglomerate (described in example 1.1) | 78 wt % |
| Sodium bicarbonate | 19.3 wt % |
| Sodium sulphite | 0.5 wt % |
| Polyvinylpyrrolidone | 0.2 wt % |
| Hydrophobic silica | 0.5 wt % |
| Dry-add perfume | 0.5 wt % |
| Spray-on perfume | 0.2 wt % |
| Orange Dye | 0.8 wt % |

1.4 Finished Product Process

The above described anionic surfactant agglomerate (described in example 1.1) is mixed with solid material comprising sodium bicarbonate, sodium sulphite, polyvinylpyrrolidone, hydrophobic silica and dry-add perfume. The sprayed-on perfume and orange dye (in liquid form) are then sprayed on to this mixture to obtain a solid laundry detergent composition described in more detail above (example 1.3).

### Example 2

As example 1, except that some of the sodium sulphate is added into the Lodige KM mixer, in addition to the Lodige CB mixer.

### Example 3

As in example 1, except that the agglomerate comprises 37 wt % sodium sulphate (instead of 40 wt %) and 3 wt % zeolite A. The zeolite A is added into the fluid bed dryer in fine particulate form having a weight average particle size of from 2 micrometers to 25 micrometers.

### Example 4

As in example 1 except that the solid laundry detergent composition comprises 76 wt % anionic surfactant agglomerate (described in example 1.1) and 2 wt % zeolite A. The zeolite A is in fine particulate form having an average particle size of from 2 micrometers to 25 micrometers and is added to the anionic surfactant agglomerate in the finished product process along with the other dry-added materials such as the sodium bicarbonate.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A solid laundry detergent composition comprising:
(a) a linear alkyl benzene sulphonate surfactant;
(b) an alkoxylated alkyl sulphate surfactant having an average degree of alkoxylation of from 1 to 7;
(c) from 0.1 wt % to 10 wt % alkoxylated alkyl alcohol having an average degree of alkoxylation of from 50 to 100; and
(d) from 0.001 wt % to 0.5 wt % polyethylene glycol;
(e) from 0 wt % to 5 wt % zeolite builder;
(f) from 0 wt % to 5 wt % phosphate builder; and
(g) optionally, one or more adjunct components;
wherein the weight ratio of the alkoxylated alkyl alcohol to the polyethylene glycol is in the range of from 9:1 to 1,000:1.

2. A composition according to claim 1, wherein the alkoxylated alkyl alcohol is an ethoxylated tallow alkyl alcohol.

3. A composition according to claim 1, wherein the alkoxylated alkyl sulphate surfactant is an ethoxylated C₁₂-C₁₅ alkyl sulphate

4. A composition according to claim 1, wherein the composition comprises from 1 wt % to 5 wt % alkoxylated alkyl alcohol having an average degree of alkoxylation of from 50 to 100.

5. A composition according to claim 1, wherein the composition comprises from 0.01 wt % to 0.1 wt % polyethylene glycol.

6. A composition according to claim 1, wherein the weight ratio of the alkoxylated alkyl alcohol to the polyethylene glycol is in the range of from 30:1 to 100:1.

7. A composition according to claim 1, wherein the linear alkyl benzene sulphonate surfactant, the alkoxylated alkyl sulphate surfactant, the alkoxylated alkyl alcohol and the polyethylene glycol are in the form of a co-particulate admix.

8. A composition according to claim 1, wherein the composition comprises sodium carbonate and sodium sulphate, and wherein the weight ratio of sodium carbonate to sodium sulphate is in the range of from 0.1:1 to 1.5:1.
